(19) United States
(12) Patent Application Publication
(10) Pub. No.: US 2009/0101689 A1
(43) Pub. Date: Apr. 23, 2009

(54) PLACING UNIT FOR PLACING LOCKING RING BOLTS

(75) Inventor: Lothar WILLE, Moerfelden-Walldorf (DE)

Correspondence Address: GREENBLUM & BERNSTEIN, P.L.C., 1950 ROLAND CLARKE PLACE, RESTON, VA, 20191, US

(73) Assignee: GESIPA Blindniettechnik GmbH,, Frankfurt (DE)

(21) Appl. No.: 12/252,711

(22) Filed: Oct. 16, 2008

(30) Foreign Application Priority Data
Oct. 20, 2007 (DE) 10 2007 050 248.8

(51) Int. Cl. B25C 7/00; B23P 11/00; B23P 17/00

(52) U.S. Cl. 227/77; 29/517; 29/525.02; 29/525.05

(57) ABSTRACT

Placing unit and method for placing locking ring bolts. The placing unit includes a gripping jaw housing in which at least two gripping jaws are arranged, a housing that surrounds the gripping jaw housing, a tip with an opening is arranged on a front face of the housing, and an opening element that limits an axial movement of the gripping jaws in one direction, while allowing the gripping jaw housing to move further in the one direction. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 10 2007 050 248.8 filed Oct. 20, 2007, the disclosure of which is expressly incorporated by reference herein in its entirety.

### BACKGROUND OF THE INVENTION

1. Field of the Invention

Embodiments of the invention relate to a placing unit for placing locking ring bolts. The unit includes a housing that surrounds a gripping jaw housing in which at least two gripping jaws are arranged. A tip with an opening is arranged on a front face of the housing.

2. Discussion of Background Information

Locking ring bolts are used to connect components, with which a high-strength and vibrationally safe connection is necessary. A locking ring bolt is thereby guided from the rear or blind side of the components through an opening and a locking ring is screwed from the front of the component onto the locking ring bolt. Finally, with the aid of a placing device, the locking ring is deformed so that it produces a positive connection with the locking ring bolt. To this end the locking ring bolt as a rule has grooves, wherein the locking ring is pressed into these grooves.

The placing operation thereby takes place as follows: After the locking ring has been pushed over the locking ring bolt, the locking ring bolt is guided into the tip of the placing device. Holding grooves of the locking ring bolt thereby slip over the holding grooves of the gripping jaws conventionally used until the tip comes to rest against the locking ring. The gripping jaws are as a rule conically supported in the gripping jaw housing, and they are pressed by a spring against the conical support. During introduction of the locking ring bolt, it is necessary to press the gripping jaws against the spring force.

After the tip comes to rest against the locking ring, an axial tensile force is generated that axially displaces the gripping jaw housing with respect to the housing of the placing device. Due to the conical support of the gripping jaws in the gripping jaw housing, the gripping jaws are pressed together and thus exert a radial holding power on the locking ring bolt, which is then together with the gripping jaws and the gripping jaw housing drawn into the housing of the placing device. The axial tensile force thereby also causes a pulling-in of the locking ring into the tip, which is deformed thereby. The tip is thereby coordinated with the locking ring in shape, length and contour. Through the deformation of the locking ring, it flows into the grooves of the locking ring bolt, whereby a very secure and permanent connection between the locking ring bolt and the locking ring occurs. The tensile force is thereby applied to the locking ring bolt during the entire deformation operation so that the finished connection has a certain prestressing.

After the locking ring has been completely accommodated in the tip or the tip bears against a collar of the tip, the deformation of the locking ring has been completed. Due to the increasing tensile force, a tear of the locking ring bolt occurs at a predetermined breaking point. The torn off part of the locking ring bolt thereby continues to be held by the gripping jaws. The locking ring is as a rule clamped in the tip.

Usually, the locking ring is pushed out of the tip by the backward movement of the gripping jaw house following the pulling motion. The backward movement is thereby usually generated by spring force. First the torn-off part of the locking ring bolt thereby comes into contact again with the part of the locking ring bolt remaining in the locking ring and is pushed further into the device until the front face of the gripping jaw housing bears against the locking ring and presses it out of the tip. Often an ejector element or an appendage is arranged for this purpose on the front face of the gripping jaw housing. The torn-off part of the locking ring bolt remains in the placing device, wherein it is still held by the gripping jaws. With the introduction of a new bolt, the torn-off part must be pressed past the gripping jaws and further into the device, wherein the holding force of the gripping jaws must be overcome thereby. To introduce a new locking ring bolt, therefore a certain force is necessary, which is why the new locking ring bolt must be secured from the rear of the components. The gripping jaws wear relatively quickly due to the slipping of the locking ring bolt over the gripping jaws. This is in particular the case when the gripping jaws have holding grooves that are designed to ensure a safe power transmission to the locking ring bolt and engage in corresponding grooves on the shank of the locking ring bolt.

### SUMMARY OF THE INVENTION

The present invention renders possible a simple removal of the torn-off part of a locking ring bolt.

According to embodiments of the invention, a placing unit of the type mentioned at the outset has an opening element that limits an axial movement of the gripping jaws in one direction. The gripping jaw housing can still be moved in this direction.

An axial relative movement between gripping jaws and a gripping jaw housing is thus caused, which, due to the conical support of the gripping jaws in the gripping jaw housing, leads to a radial expansion of the gripping jaws. A targeted opening of the gripping jaws is thus possible. Through the axial relative movement between gripping jaws and gripping jaw housing, the torn-off part of the locking ring bolt remaining in the placing unit can thus be released and removed without a great expenditure of force. An automatic removal is thus also possible, e.g., by vacuum suctioning. The introduction of a new locking ring bolt is also considerably simplified, since it no longer needs to first push the gripping jaws apart during introduction. A retention of the locking ring bolt from the rear of the components, for which as a rule a second person is required, can thus be omitted.

It is particularly preferred that the opening element has at least one appendage that projects through an opening in the gripping jaw housing. The gripping jaw housing as well as the gripping jaws can thus perform a relative movement to the opening element that can therefore be arranged in a locally fixed manner in the housing of the placing unit. As soon as the gripping jaws come into contact with the appendage, another movement of the gripping jaws in the direction towards the opening element is prevented. In this manner, movement of the gripping jaw housing is not blocked. The movement direction that is limited by the opening element corresponds, e.g., to the direction of the reset movement with which the gripping jaw housing with the gripping jaws is moved in the direction of the tip. The opening element thus causes an opening of the gripping jaws during the reset movement.

The appendage is preferably embodied or formed in a sleeve-shaped manner and a locking ring bolt can be guided through the opening. The appendage and the locking ring bolt can thus project through the same opening in the gripping jaw housing. The locking ring bolt is likewise surrounded and optionally guided by the sleeve-shaped appendage. Additional openings in the gripping jaw housing are not required.

The gripping jaws preferably surround an interior, and are formed with holding grooves on their inside. The interior serves to accommodate the locking ring bolt, which can be inserted through the tip and the opening in the gripping jaw housing. Through the holding grooves arranged on their inside, the gripping jaws can transfer great forces to the locking ring bolt and hold it securely.

Preferably, the interior continues through the placing unit. It is thus possible to remove the torn-off part of the locking ring bolt from the side of the housing of the placing unit facing away from the tip. It is conceivable thereby that the placing unit is connected to a vacuum unit that suctions the torn-off part of the locking ring bolt through the interior and thus automatically removes the torn-off part.

The placing unit preferably has an ejector, which is arranged between the opening element and the opening of the tip. This ejector is used to eject the locking ring out of the tip after the placing operation has been completed. In this way, a retractive force, transferred via the ejector from the gripping jaw housing to the locking ring, finally leads to the ejection of the locking ring out of the tip. The embodiment of the gripping jaw housing can thus be kept relatively simple, since it does not need to have a corresponding ejection mechanism.

It is particularly preferred that the ejector has an appendage that extends into the opening of the tip and has a length that corresponds at least to a depth of the opening. The appendage of the ejector can thus completely penetrate the opening of the tip. It is thus ensured that the ejector can completely eject the locking ring out of the tip. At the same time, it is ensured that the ejector already bears against the locking ring at the start of the placing operation. During ejection, the ejector thus comes into contact with the locking ring at the same time as the torn-off part of the locking ring bolt that remains in the locking ring. A displacement of the torn-off part of the locking ring bolt during the reset movement is therefore not necessary. At the moment when the gripping jaws firmly grip the locking ring bolt, as far as possible there is no contact between the tip and the locking ring or the locking ring has just come to rest on the tip. The contact between the gripping jaw housing and ejector or ejector and locking ring is thus maintained during the entire pulling operation.

Preferably, the appendage is embodied or formed in a sleeve-shaped manner and in one piece with the ejector. Through the sleeve-shaped embodiment, the appendage can surround the locking ring bolt and thus serve as a guide, whereby a good transfer of force to the locking ring is ensured. Through the one-piece embodiment with the ejector, the production, for example as an injection molded part, is relatively simple and cost-effective.

Preferably, the ejector has at least one pin that extends through at least one recess in the opening element in the direction of the gripping jaw housing. This pin ensures that the ejector can be brought into contact with the gripping jaw housing without an influencing by the opening element occurring. While a relative movement of the ejector in the housing is necessary, the opening element can be arranged in the housing in a fixed manner. The relative movement between ejector and opening element is thereby rendered possible in that the pin projects through the recess in the opening element.

Preferably, the ejector has several pins that are embodied or formed as circle segments. The pins are embodied or formed in one piece with the ejector. The pins thus serve at the same time as guides of the ejector in the opening element. Through the embodiment of the pins as circle segments, a tilting of the ejector is virtually ruled out. At the same time, the pins can be embodied or formed with a relatively large amount of material so that a good transfer of force is possible. The one-piece embodiment of the pins with the ejector thereby guarantees a cost-effective production.

Preferably, the pins have a greater axial length than the appendage of the opening element. The appendage of the opening element is only to ensure a relatively small relative movement between the gripping jaws and the gripping jaw housing through which a secure opening of the gripping jaws is ensured. The ejector, however, is moved by a greater length, which corresponds at least to the axial extension of the locking ring.

Since the pins now have a greater axial length than the appendage of the opening element, there can be a contact between the gripping jaw housing and the ejector at least until the locking ring bolt is torn off. This ensures that during the reset movement the locking ring can be pressed out of the tip through the gripping jaw housing via the ejector, without the torn-off part of the locking ring bolt having to be pushed inside the gripping jaws.

Embodiments of the invention are directed to a placing unit for placing locking ring bolts. The placing unit includes a gripping jaw housing in which at least two gripping jaws are arranged, a housing that surrounds the gripping jaw housing, a tip with an opening is arranged on a front face of the housing, and an opening element that limits an axial movement of the gripping jaws in one direction, while allowing the gripping jaw housing to move further in the one direction than the gripping jaws

According to features of the embodiments of the invention, gripping jaw housing can have an opening, and the opening element can have at least one appendage projecting through the opening in the gripping jaw housing.

In accordance with other features, the appendage may have a sleeve-shape and the opening is structured and arranged to receive a locking ring bolt.

Moreover, the gripping jaws may have holding grooves on insides arranged to surround an interior. The interior can extend through the placing unit.

According to further embodiments, an ejector can be arranged between the opening element and the opening of the tip. The ejector may have an appendage extending into the opening of the tip and can have a length that corresponds at least to a depth of the opening. The appendage may have a sleeve-shape and the ejector is formed in one piece. Further, the ejector can have at least one pin extending through at least one recess in the opening element in the direction of the gripping jaw housing. The ejector may also have several pins formed as circle segments, and the ejector is formed in one piece.

In accordance with other embodiments, the pins may have a greater axial length than the appendage of the opening element.

Embodiments of the invention are directed to a method for placing locking ring bolts. The method includes pulling a part of a locking ring bolt in a first direction with gripping jaws in a gripping jaw housing until a portion of the locking ring bolt breaks free, and moving the gripping jaws and the gripping jaw housing in a second direction opposite the first direction. An opening element allows greater movement in the second direction for the gripping jaw housing than the gripping jaws.

According to feature of the embodiments, an appendage of the opening element extending through an opening in the gripping jaw housing can halt movement of the gripping jaws in the second direction.

In accordance with other embodiments, the method can further include suctioning the portion of the locking ring bolt into a stem holder.

According to embodiments of the invention, the gripping jaw housing can be moved through action with an ejector. Further, after movement of the ejector is halted, the method may further include moving the gripping jaw housing way from the ejector. The method can also include moving the ejector though an interaction between an appendage of the ejector and a locking ring.

Moreover, the method can also include moving an ejector coupled to move the gripping jaw housing relative to the opening element. The opening element can be positionally fixed.

Embodiments of the invention are directed to a placing unit for placing locking ring bolts. The placing unit includes at least two gripping jaws structured and arranged for at least axial movement, a gripping jaw housing arranged to move the at least two gripping jaws, and an opening element that limits the axial movement of the gripping jaws in a resetting direction but does not limit the axial movement of the gripping jaw housing in the resetting direction.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a placing unit with attached placing unit for placing locking ring bolts;

FIG. 2 illustrates a cross section of a placing unit before an application of a tensile force;

FIG. 3 illustrates a cross section of the placing unit after the start of the placing operation;

FIG. 4 illustrates a cross section of the placing unit after completion of the placing operation; and

FIG. 5 illustrates a detailed view of the ejector.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

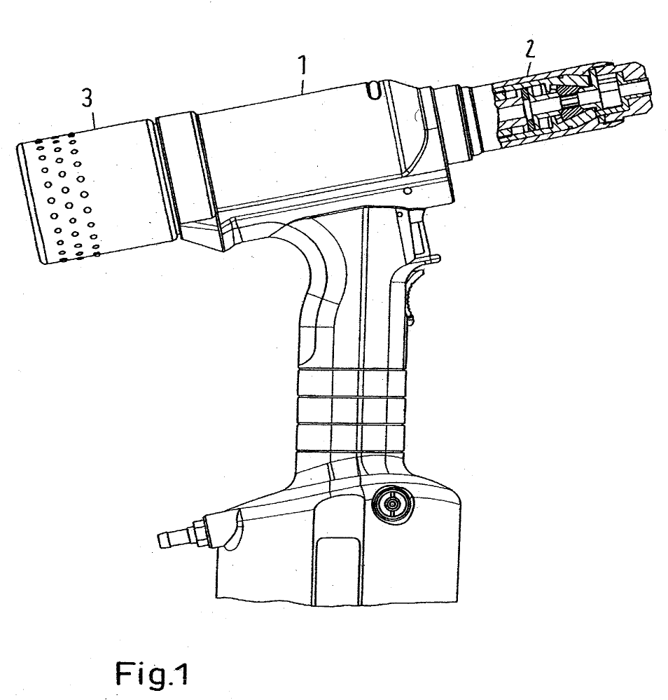

FIG. 1 shows a placing device 1 with a placing unit 2 according to the invention. In this exemplary embodiment, placing device 1 is a pneumatic-hydraulic placing device. However, the placing unit 2 can also be used in connection with other placing devices, such as, e.g., electrically drive devices or hand-operated devices and the like. Placing device 1 is furthermore provided with a stem holder 3, which serves to accommodate the torn-off parts of the locking ring bolt. To this end the torn-off part of the locking ring bolt is suctioned by a vacuum.

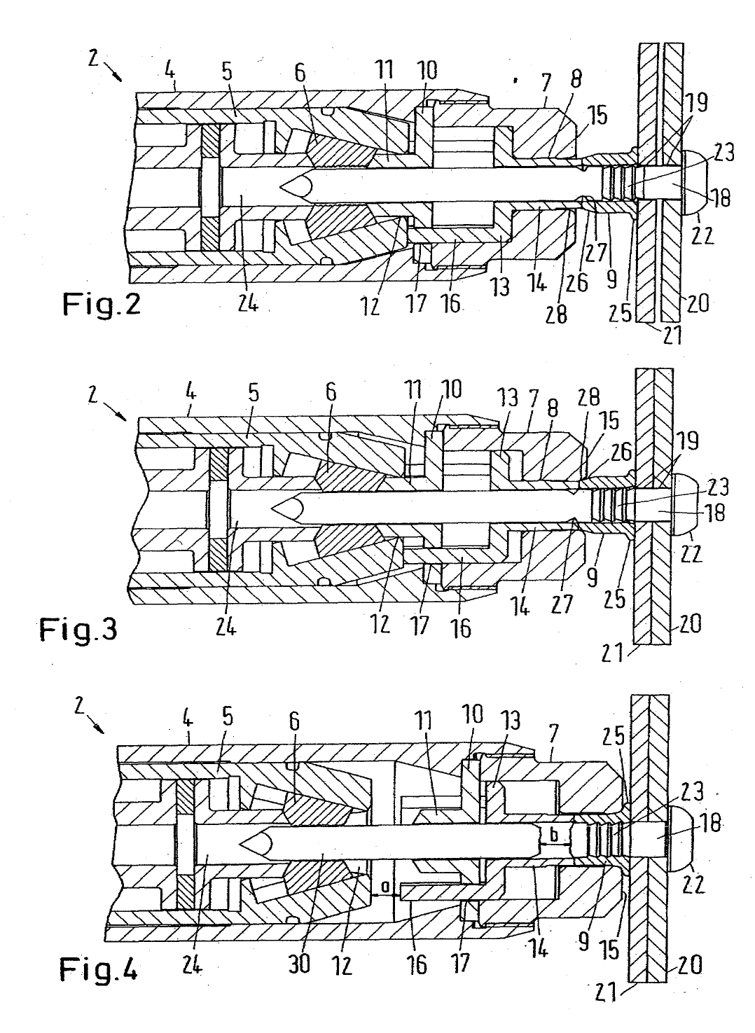

FIG. 2 shows placing unit 2 in section view. Placing unit 2 has a housing 4 in which a gripping jaw housing 5 is arranged in an axially displaceable manner. A number of gripping jaws 6, e.g., three, are arranged inside gripping jaw housing 5. It is also conceivable to use a different number of gripping jaws, for example, two to six. Housing 4 is closed on a front face by a tip 7 that has an opening 8, which is provided with a corresponding contour for deforming a locking ring 9. Gripping jaws 6 are axially displaceable in gripping jaw housing 5 and conically supported in gripping jaw housing 5 on their side facing towards tip 7. An opening element 10 is arranged in housing 4 between gripping jaw housing 5 and tip 7. Opening element 10 is pressed by tip 7, which is screwed into housing 4, against a radial projection in housing 4 and thus fixed in its position.

Opening element 10 has a sleeve-shaped appendage 11 that extends through an opening 12 in gripping jaw housing 5. In the initial position shown, gripping jaws 6 are in contact with appendage 11 of opening element 10. Gripping jaws 6 can thereby be loaded, e.g., by a spring (not shown) in the direction of tip 7. Other reset possibilities are conceivable. An ejector 13 is arranged between opening element 10 and tip 7, which ejector has a sleeve-shaped appendage 14, which extends through opening 8 in the tip 7, wherein the length of appendage 14 is greater than the depth of opening 8. Appendage 14 thus projects beyond a front face 15 of tip 7, so that appendage 14 upon placement of placing unit 2 first comes into contact with locking ring 9. Ejector 13 furthermore has several pins 16, which extend in the opposite direction from appendage 14. The pins 16 thereby project through recesses 17 in opening element 10 and are in contact with gripping jaw housing 5.

A locking ring bolt 18 has been inserted through a bore 19 in two components 20 and 21 to be connected, so that a manufactured rivet head 22 of locking ring bolt 18 bears against a rear side of component 20. Locking ring 9 has already been pushed over locking ring bolt 18 and surrounds grooves 23 of locking ring bolt 18. Locking ring bolt 18 extends thereby up to into an interior 24 of placing unit 2. Interior 24 is thus formed, e.g., by opening 8 in tip 7, opening 12 in gripping jaw housing 5, and the area between gripping jaws 6. However, interior 24 continues further through placing unit 2, and extends up into stem holder 3.

Locking ring 9 has a circumferential collar 25 on an end facing components 20 and 21. On the opposite end, locking ring 9 is provided with a chamfer 26 that is designed to facilitate the insertion into the opening 8. Locking ring bolt 18 has a predetermined breaking point 27, which is positioned so that after a break of locking ring bolt 18, the part of locking ring bolt 18 remaining in locking ring 9 is approximately flush with locking ring 9.

FIG. 3 now shows a situation shortly after the start of the pulling operation. After gripping jaws 6 have gripped locking ring bolt 18, a further pulling movement of gripping jaw housing 5 leads to components 20 and 21 being pressed against locking ring 9. Locking ring 9 is thus inserted through opening 8 somewhat into tip 7, which is facilitated by a chamfer 28 on the tip 7. Ejector 13 is thereby pushed through locking ring 9 axially in the direction of gripping jaw housing 5. To be more exact, locking ring 9, ejector 13 and gripping jaw housing 5 remain stationary, while housing 4 with tip 7 is pushed over locking ring 9. Gripping jaw housing 5 is thus also moved relative to housing 4 and gripping jaws 6, i.e., to the left in the drawing. The gripping jaws 6 are thereby moved radially towards one another and enclose locking ring bolt 18. Gripping jaws 6 thereby have holding grooves 29 that ensure a secure hold of locking ring bolt 18.

Through a placing mechanism, gripping jaw housing 5 together with gripping jaws 6 and locking ring bolt 18 is pulled relative to housing 4, i.e., to the left in the drawing, away from the tip. The force flow is thereby closed again through housing 4, which transfers this force via tip 7, locking ring 9 and finally to components 20 and 21. Through the movement of gripping jaw housing 5, first gripping jaws 6 are pressed firmly against locking ring bolt 18, so holding grooves 29 can thereby bury themselves in locking ring bolt 18. Subsequently, gripping jaws 6 together with locking ring bolt 18 and gripping jaw housing 5 are pulled into the interior of the placing unit. The two components 20 and 21 are thereby also pressed to one another.

This tensile force now leads to locking ring 9 being drawn into opening 8 of tip 7 or to tip 7 being drawn over locking ring 9. Since the outside diameter of locking ring 9 is greater than the inside diameter of opening 8, and tip 7 is produced in a corresponding stable manner, a plastic deformation of locking ring 9 takes place such that portions flow into grooves 23 of locking ring bolt 18. A high-strength positive connection between locking ring 9 and locking ring bolt 19 is thus produced.

As illustrated in FIG. 4, the deformation of locking ring 9 has been completed when front face 15 of tip 7 bears against collar 25 of locking ring 9. This is shown in FIG. 4. A further relative movement between placing unit 2 and locking ring 9 or locking ring bolt 18 is no longer possible because tip 7 bears against collar 25 of locking ring 9, which leads to an increase in the tensile force until finally the locking ring bolt 18 is torn apart along predetermined breaking point 27. A torn-off part 30 of locking ring bolt 18 thereby continues to be held by gripping jaws 6. In the state shown in FIG. 4, gripping jaw housing 5 is located in its one axial end position in which it adopts a maximum distance from tip 7. The pulling movement is thus ended. Until locking ring bolt 18 is torn off, pins 16 were in contact with gripping jaw housing 5 during the entire placing operation. After locking ring bolt 18 has been torn off, gripping jaw housing 5 is at a distance a from pins 16. The spacing a thereby corresponds to a spacing b between torn-off part 30 and part of the locking ring bolt 18 held in locking ring 9.

Gripping jaw housing 5 is now moved, e.g., by spring force or by a pneumatic force or in another manner back into the starting position shown in FIG. 2, i.e., in the direction towards tip 7. Since the spacing a between the gripping jaw housing 5 and pins 16 of ejector 13 is the same size as the spacing b between torn off part 30 and locking ring bolt 18, gripping jaw housing 5 comes into contact with pins 16 at the same time as torn-off part 30 of locking ring bolt 18 with locking ring bolt 18. The reset movement of gripping jaw housing 5 can thus be transferred via ejector 13, in particular via pins 16 thereof and appendage 14 thereof, directly to locking ring 9, without torn off part 30 having to be pushed into gripping jaws 6. Locking ring 9 is thus pushed out of tip 7 through the backward movement of gripping jaw housing 5 that is transferred via ejector 13. Since the length of appendage 14 is longer than the depth of opening 8, it is ensured thereby that locking ring 9 is completely removed.

Shortly before gripping jaw housing 5 has reached its axial final position in which a further movement of ejector 13 in the direction towards opening 8 is not possible, appendage 11 of opening element 10 comes into contact with gripping jaws 6 and prevents them from being moved further with gripping jaw housing 5. A relative movement between gripping jaws 6 and gripping jaw housing 5 is thus produced, which leads to a radial expansion of gripping jaws 6 due to the conical support of gripping jaws 6 in gripping jaw housing 5. Torn-off part 30 of locking ring bolt 18 is thus released by gripping jaws. Torn-off part 30 can be easily suctioned off through the application of a vacuum to interior 24.

Placing unit 2 is now free for a new placing operation, wherein an easy insertion of a new locking ring bolt 18 is possible, since gripping jaws 6 continue to be held open by opening element 10. The adjustment of placing unit 2 to different sizes of the locking ring bolt and of the locking ring is possible through a simple replacement of tip 7, of ejector 13 and of opening element 10. Since these elements are all held in housing 4 through tip 7, a replacement of this type can also be carried out quickly. Tip 7 is connected to housing 4 via a thread in this exemplary embodiment, but other embodiments are also conceivable.

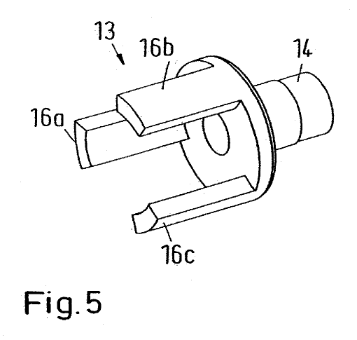

FIG. 5 shows a detailed view of ejector 13. Ejector 13 has three circular pins 16a, 16b, 16c, that serve to guide ejector 13 into recesses 17 of opening element 10. Sleeve-shaped appendage 14 extends in the opposite direction from pins 161, 16b, 16c, and is inserted into opening 8 of tip 7. The free inside diameter of sleeve-shaped appendage 14 thereby corresponds approximately to the outside diameter of locking ring bolt 18, whereby a guide of locking ring bolt 18 takes place during insertion into placing unit 2.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended functionally equivalent structures, methods and uses, such as are within the scope of the appended claims.

What is claimed:

1. A placing unit for placing locking ring bolts, comprising:
a gripping jaw housing in which at least two gripping jaws are arranged;
a housing that surrounds the gripping jaw housing;
a tip with an opening is arranged on a front face of the housing; and
an opening element that limits an axial movement of the gripping jaws in one direction, while allowing the gripping jaw housing to move further in the one direction than the gripping jaws.

2. The placing unit in accordance with claim 1, wherein gripping jaw housing has an opening, and the opening element has at least one appendage projecting through the opening in the gripping jaw housing.

3. The placing unit in accordance with claim 1, wherein the appendage has a sleeve-shape and the opening is structured and arranged to receive a locking ring bolt.

4. The placing unit in accordance with claim 1, wherein the gripping jaws have holding grooves on insides arranged to surround an interior.

5. The placing unit in accordance with claim 4, wherein the interior extends through the placing unit.

6. The placing unit in accordance with claim 1, further comprising an ejector arranged between the opening element and the opening of the tip.

7. The placing unit in accordance with claim 6, wherein the ejector has an appendage extending into the opening of the tip and has a length that corresponds at least to a depth of the opening.

8. The placing unit in accordance with claim 7, wherein the appendage has a sleeve-shape and the ejector is formed in one piece.

9. The placing unit in accordance with claim 6, wherein the ejector has at least one pin extending through at least one recess in the opening element in the direction of the gripping jaw housing.

10. The placing unit in accordance with claim 6, wherein the ejector has several pins formed as circle segments, and the ejector is formed in one piece.

11. The placing unit in accordance with claim 1, wherein the pins have a greater axial length than the appendage of the opening element.

12. A method for placing locking ring bolts, comprising:
pulling a part of a locking ring bolt in a first direction with gripping jaws in a gripping jaw housing until a portion of the locking ring bolt breaks free;
moving the gripping jaws and the gripping jaw housing in a second direction opposite the first direction; and
wherein an gripping element allows greater movement in the second direction for the gripping jaw housing than the gripping jaws.

13. The method in accordance with claim 12, wherein an appendage of the opening element extending through an opening in the gripping jaw housing halts movement of the gripping jaws in the second direction.

14. The method in accordance with claim 12, further comprising suctioning the portion of the locking ring bolt into a stem holder.

15. The method in accordance with claim 12, wherein the gripping jaw housing is moved through action with an ejector.

16. The method in accordance with claim 15, wherein, after movement of the ejector is halted, the method further comprises moving the gripping jaw housing way from the ejector.

17. The method in accordance with claim 15, further comprising moving the ejector though an interaction between an appendage of the ejector and a locking ring.

18. The method in accordance with claim 12, further comprising moving an ejector coupled to move the gripping jaw housing relative to the opening element.

19. The method in accordance with claim 18, wherein the opening element is positionally fixed.

20. A placing unit for placing locking ring bolts, comprising:
at least two gripping jaws structured and arranged for at least axial movement;
a gripping jaw housing arranged to move the at least two gripping jaws; and
an opening element that limits the axial movement of the gripping jaws in a resetting direction but does not limit the axial movement of the gripping jaw housing in the resetting direction.
